(19) United States
(12) Patent Application Publication
(10) Pub. No.: US 2013/0008329 A1
(43) Pub. Date: Jan. 10, 2013

(54) Ink Cup

(75) Inventor: Wang Man HO, Hong Kong (HK)

(73) Assignee: KENT ENGINEERING (GAO YAO) CO. LTD., Zhao Qing (CN)

(21) Appl. No.: 13/239,016

(22) Filed: Sep. 21, 2011

(30) Foreign Application Priority Data
Jul. 5, 2011 (HK) 11106937.0

(51) Int. Cl. B41K 1/38

(52) U.S. Cl. 101/335

(57) ABSTRACT

An ink cup (10) for a printing machine is disclosed as including a body (11) with a cavity (34) for containing a solvent (35) and a cavity (28) for containing an ink (26), and a screw valve (36) movable relative to the body (11) between a first position in which the two cavities (34, 28) are in a liquid-non-communicable relationship and a second position in which the two cavities (34, 28) are in a liquid-communicable relationship.

### TECHNICAL FIELD

This invention relates to an ink cup for a printing machine (such as an ink cup for a pad printing machine) and an accessory for an ink cup for a printing machine.

### BACKGROUND

Existing ink cups for printing machines have a body made of a metal (e.g. aluminum) or metal alloy. The body of such a conventional ink cup has a cavity with an open end. The ink cup is placed on a major surface of a metal printing plate for sliding movement relative to the printing plate. Printing ink is contained with the cavity of the ink cup body and, in use, the ink is held between the ink cup body and the printing plate.

At least one pattern is engraved on the major surface of the metal printing plate on which the ink cup slides. When the ink cup slides across the engraved pattern, some ink in the cavity of the ink cup body is left in the engraved pattern, to be picked up by a printing head (e.g. a silicone printing pad) of the printing machine for printing purpose.

To achieve consistent and satisfactory printing effect, the ink in the cavity of the ink cup body should be kept at an appropriate viscosity or within an acceptable range of viscosity, by adjusting the concentration of solvent in the ink. It is known in practice that the solvent in the ink evaporates during use, so that the ink becomes more and more viscous upon use. Operation of the printing machine may have to be stopped to allow addition of solvent, which will slow down the printing process and cause variation in the printing quality.

### SUMMARY OF THE INVENTION

It is thus an object of the present invention to provide an improved ink cup for a printing machine and an accessory for an ink cup for a printing machine in which the aforesaid shortcoming is mitigated, or at least to provide a useful alternative to the trade and public. Other advantages of the ink cup for a printing machine and the accessory for an ink cup for a printing machine according to the present invention will become apparent from the following discussion.

According to a first aspect of the present invention, there is provided an ink cup for a printing machine, said ink cup including a body with a first cavity and a second cavity, and a valve member movable relative to said body between a first position in which said first cavity and said second cavity are in a liquid-non-communicable relationship and a second position in which said first cavity and said second cavity are in a liquid-communicable relationship, wherein, when said valve member is in said second position, a liquid in said first cavity is adapted to enter said second cavity at a first substantially constant rate, wherein said valve member is movable relative to said body to a third position in which said first cavity and said second cavity are in a liquid-communicable relationship, and wherein when said valve member is in said third position, a liquid in said first cavity is adapted to enter said second cavity at a second substantially constant rate which is different from said first substantially constant rate.

According to a second aspect of the present invention, there is provided an accessory for an ink cup for a printing machine, said accessory including a body with a cavity having a first opening and a second opening, and a valve member movable relative to said body between a first position in which a liquid in said cavity is prevented from exiting said body via said second opening and a second position in which a liquid in said cavity is allowed to exit said body via said second opening, wherein, when said valve member is in said second position, a liquid in said first cavity is adapted to exit said body via said second opening at a first substantially constant rate, wherein said valve member is movable relative to said body to a third position in which a liquid in said cavity is allowed to exit said body via said second opening, and wherein when said valve member is in said third position, a liquid in said first cavity is adapted to exit said body via said second opening at a second substantially constant rate which is different from said first substantially constant rate.

### BRIEF DESCRIPTION OF THE DRAWINGS

An ink cup for a printing machine according to an embodiment of the present invention will be discussed with reference to the accompanying drawings in which:

FIG. 1 is a longitudinal sectional view of an ink cup for a printing machine according to an embodiment of the present invention; and

FIG. 2 is an enlarged view of the encircled part in FIG. 1.

### DETAILED DESCRIPTION OF THE INVENTION

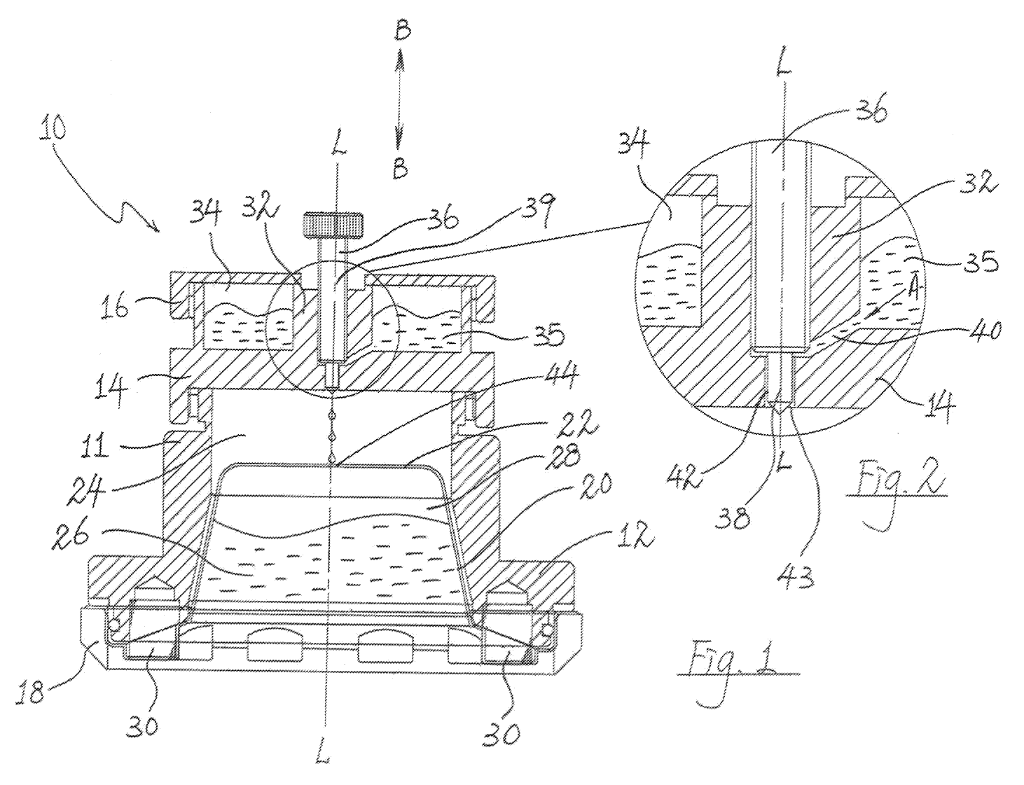

A longitudinal sectional view of an ink cup for a printing machine according to an embodiment of the present invention is shown in FIG. 1 in an in-use orientation, which ink cup being generally designated as 10. The ink cup 10 has a body 11 formed of a lower body 12 and an upper body 14. The lower body 12 is threadedly engaged with the upper body 14, and the upper body 14 is threadedly engaged with a cover 16. Each of the lower body 12, upper body 14 and cover 16 is made of a metal or metal alloy, e.g. aluminum. The material with which each of the lower body 12, upper body 14 and cover 16 is made may be different or the same. In the present embodiment, the lower body 12 and the upper body 14 are two separate components releasably and threadedly engageable with each other. It is of course possible to form a body 11 in which the lower body 12 and the upper body 14 are integrally formed with each other.

To a lower circular rim of the lower body 12 is fixedly engaged with a circular ring 18, which may be made of ceramic or a metal. In use, the ring 18 is in contact with an upper major surface of a metal printing plate formed (e.g. by engraving) with at least one recessed pattern. An ink bowl 20 with a lower open end and an opposite upper wall 22 is engaged with the lower body 12. In particular, the ink bowl 20 is received within a recess 24 of the lower body 12. Printing ink 26 is received within a cavity 28 within the ink bowl 20. In use, the ink cup 10 is slidingly movable on and relative to the printing plate, with the ring 18 being in contact with the printing plate, to leave ink originally in the ink bowl 20 on the recessed pattern on the printing plate for printing purpose. To prevent the ink cup 10 from being accidentally displaced from the printing plate, a number of magnets 30 are enclosed within cavities between the lower rim of the lower body 12 and the ring 18. These magnets 30 serve to attract the ink cup 10 to the printing plate in use.

The upper body 14 has a central cylinder 32 which is surrounded by an annular cavity 34 with an open upper end. A solvent 35 for the ink 26 may be introduced into the cavity 34 of the upper body 14 through its open upper end. The cylinder 32 has a central threaded bore which is threadedly engaged with a screw valve 36. The screw valve 36 is movable relative to the upper body 14 (and thus the ink cup 10) up and down, i.e. in the directions indicated by the bi-directional arrow B-B in FIG. 1. The screw valve 36 has an end pin 38 and a threaded portion 39: The diameter of the end pin 38 is smaller than the diameter of the threaded portion 39. The cover 16 is releasably engageable with the upper body 14 to prevent or at least reduce evaporation of the solvent 35 received within the cavity 34 to the outside environment.

As can be seen more clearly in FIG. 2, a channel 40 in the upper body 14 leads from a lower portion of the annular cavity 34 of the upper body 14 to a tunnel 42, which in turn leads to an opening 43 at the bottom of the upper body 14. The channel 40 is slanted relative to a longitudinal axis L-L of the ink cup 10, and the tunnel 42 is parallel to the longitudinal axis L-L of the ink cup 10. Thus, in the absence of the screw valve 36, the solvent 35 in the cavity 34 will flow (under its own weight, and in the direction indicated by the arrow A in FIG. 2) through the channel 40, then through the tunnel 42, and exit the upper body 14 via the opening 43.

The end pin 38 of the screw valve 36 is of a diameter of 3 mm and the tunnel 42 is of a diameter slightly larger than 3 mm. When the screw valve 36 is rotated relative to the upper body 14 to its lowermost position, the screw valve 36 will close a lower end of the channel 40, thus blocking liquid communication between the channel 40 and the tunnel 42, i.e. no solvent 35 can flow from the cavity 34 via the channel 40 to the tunnel 42.

When the screw valve 36 is rotated to move upwardly relative to the upper body 14 to an upper position, a gap is opened between the channel 40 and the tunnel 42, thus allowing the solvent 35 in the cavity 34 to flow through the channel 40 to the tunnel 42, eventually exiting the upper body 14 via the opening 43. The small difference between the diameter of the tunnel 42 and the diameter of the end pin 38 has the effect of ensuring that the solvent 35 exits the tunnel 42 at a constant rate and in drops.

When the screw valve 36 is rotated to move further upward relative to the upper body 14 to a further upper position, a wider gap is opened between the channel 40 and the tunnel 42. Therefore, solvent 35 in the cavity 34 will flow through the channel 40 and the tunnel 42, and exit the upper body 14 via the opening 43 of the tunnel 42 at a higher constant rate, also in drops. Thus, by adjusting the position of the screw valve 36 relative to the upper body 14 (and thus relative to the body 11), one may (a) selectively allow or prevent the solvent 35 in the annular cavity 34 from exiting the upper body 14 via the opening 43 of the tunnel 42 and (b) adjust the rate at which the solvent 35 in the annular cavity 34 exits the upper body 14 via the opening 43 of the tunnel 42. It should also be understood that adjusting the position of the screw valve 36 relative to the upper body 14 will also bring about a corresponding adjustment of the position of the end pin 38 within and relative to the tunnel 42 (which may alternatively be a separate steel sleeve).

In use, the opening 43 of the tunnel 42 of the upper body 14 is vertically above a hole 44 through the upper wall 22 of the ink bowl 20 in the lower body 12. The solvent 35 exiting the upper body 14 via the opening 43 of the tunnel 42 will thus fall, on its own weight and in drops, through the recess 24 in the lower body 12, and subsequently enter, through the hole 44, the cavity 28 within the ink bowl 20, and be mixed with the ink 26 in the ink bowl 20. Thorough mixing of the solvent 35 with the ink 26 in the ink bowl 20 is facilitated, in use, by movement of the ink cup 10 on and relative to the printing plate.

It can thus be seen that an advantage of the ink cup 10 according to the present invention is that the solvent 35 in the cavity 34 can be added to the ink 26 in the ink bowl 20 below the cavity 34 automatically and in a controlled manner. It is also possible for an operator to adjust the rate at which the solvent 35 is added to the ink 26 by simple operation and adjustment of the screw valve 36.

Although the upper body 14, the screw valve 36 and the cover 16 have so far been disclosed as forming part of the ink cup 10, it is envisaged that the upper body 14, the screw valve 36 and the cover 16 may form a separate accessory releasably engageable with a conventional ink cup to provide the automatic viscosity control/adjustment function.

It should be understood that the above only illustrates an example whereby the present invention may be carried out, and that various modifications and/or alterations may be made thereto without departing from the spirit of the invention. It should also be understood that various features of the invention which are, for brevity, described here in the context of a single embodiment, may also be provided separately or in any appropriate sub-combinations.

1. An ink cup for a printing machine, said ink cup including:
a body with a first cavity and a second cavity, and
a valve member movable relative to said body between a first position in which said first cavity and said second cavity are in a liquid-non-communicable relationship and a second position in which said first cavity and said second cavity are in a liquid-communicable relationship,
wherein, when said valve member is in said second position, a liquid in said first cavity is adapted to enter said second cavity at a first substantially constant rate,
wherein said valve member is movable relative to said body to a third position in which said first cavity and said second cavity are in a liquid-communicable relationship, and
wherein when said valve member is in said third position, a liquid in said first cavity is adapted to enter said second cavity at a second substantially constant rate which is different from said first substantially constant rate.

2. An ink cup according to claim 1 wherein said body includes a first body member and a second body member releasably engaged with each other, wherein said first body member includes a first opening and a second opening, wherein a liquid is adapted to enter said first cavity via said first opening, and wherein said liquid in said first cavity is adapted to exit said first body member via said second opening.

3. An ink cup according to claim 2 wherein said first body member and said second body member are threadedly engaged with each other.

4. An ink cup according to claim 2 wherein said first cavity and said second opening of said first body member are in a liquid-communicable relationship with each other via a channel, and wherein an end of said channel is closable by said valve member.

5. An ink cup according to claim 2 wherein said valve member is threadedly engaged with and movable relative to said first body member between said first position and second position.

6. An ink cup according to claim 2 wherein, when in use, said liquid exits said first body member and enters said second cavity on its own weight.

7. An ink cup according to claim 2 wherein said first body member is releasably engaged with a lid to close said first opening.

8. An ink cup according to claim 2 wherein said second body member includes an ink container with an open end and an opposite bottom with a hole.

9. An ink cup according to claim 8 wherein, when in use, said hole of said bottom of said ink container is substantially vertically below said second opening of said first body member.

10. An ink cup according to claim 1 wherein, when in use, said first cavity is above said second cavity.

11. An ink cup according to claim 1 wherein said second cavity is adapted to contain an ink and said first cavity is adapted to contain a solvent of said ink.

12. An ink cup according to claim 1 wherein, when said valve member is in said second position or said third position, a liquid in said first cavity is adapted to enter said second cavity in drops.

13. An accessory for an ink cup for a printing machine, said accessory including:
a body with a cavity having a first opening and a second opening, and
a valve member movable relative to said body between a first position in which a liquid in said cavity is prevented from exiting said body via said second opening and a second position in which a liquid in said cavity is allowed to exit said body via said second opening,
wherein, when said valve member is in said second position, a liquid in said first cavity is adapted to exit said body via said second opening at a first substantially constant rate,
wherein said valve member is movable relative to said body to a third position in which a liquid in said cavity is allowed to exit said body via said second opening, and
wherein when said valve member is in said third position, a liquid in said first cavity is adapted to exit said body via said second opening at a second substantially constant rate which is different from said first substantially constant rate.
